(19) United States
(12) Patent Application Publication
(10) Pub. No.: US 2025/0376365 A1
(43) Pub. Date: Dec. 11, 2025

(54) APPARATUS FOR CLOSING A CONTAINER

(71) Applicant: KRONES AG, Neutraubling (DE)

(72) Inventors: Markus SCHOENFELDER, Regensburg (DE); Sebastian KLEPATZ, Zeitlarn (DE); Klaus BUCHHAUSER, Deuerling (DE)

(21) Appl. No.: 19/229,356

(22) Filed: Jun. 5, 2025

(30) Foreign Application Priority Data
Jun. 5, 2024 (DE) 10 2024 115 576.0

(51) Int. Cl. B67B 3/20

(52) U.S. Cl. CPC B67B 3/2073

(57) ABSTRACT

The invention relates, inter alia, to an apparatus for closing a container, comprising a closure element, a pre-tensioning device with at least one elastic, pre-tensioned element for specifying a head pressure and a lifting cam follower for following a lifting cam. The lifting cam follower is connected to the closure element via the pre-tensioning device for vertically moving the closure element when following the lifting cam. The at least one elastic, pre-tensioned element is arranged substantially at the same height as the lifting cam follower or above the lifting cam follower. Alternatively, it is provided that a vertical extension of the at least one elastic, pre-tensioned element along a vertical axis and a vertical extension of the lifting cam follower along the vertical axis overlap or adjoin one another.

### CROSS-REFERENCE TO RELATED APPLICATIONS

This application claims the benefit under 35 U.S.C. §119(a) of German Patent Application No. DE 102024115576.0, filed June 5, 2024, entitled APPARATUS FOR CLOSING A CONTAINER, and whose entire disclosure is incorporated by reference herein.

### TECHNICAL FIELD

The invention relates to an apparatus for closing a container, comprising a pre-tensioning device which has at least one elastic, pre-tensioned element for specifying a head pressure. The invention further relates to a capper having at least one such apparatus.

### TECHNICAL BACKGROUND

When filling beverages in beverage filling plants, containers to be filled are usually filled with a filling product, for example a beverage. After filling, the filled container is closed with a container closure by an apparatus.

Depending on the type of container to be filled, different types of container closures are known. For example, it is known to close beverage bottles with a roll-on closure, a screw closure, a push-on closure or a push-in closure.

In order to provide the head pressure required for applying the closures, the apparatus can have a pre-tensioning device by which a closure receptacle is pre-tensioned relative to a lifting unit of the apparatus in the direction of the container to be closed.

For example, with known standard screw cap capping heads, the head pressure required for closing can be applied in the closure head. For this purpose, a pre-tensioned spring with a torsionally rigid length compensation element can be provided. During the closing process, the so-called head pressure is produced on the closure and the container mouth in that the pre-tensioned spring is further compressed and the length compensation compensates for the so-called overstroke.

This known pre-tensioning device is made up of many individual parts that are difficult to clean and are installed quite close to the container mouth. The compression of the pre-tensioning device during the closing process must be taken into account when designing the length of an ejector rod that may be provided. If the head pressure needs to be adjusted or set, this is quite complicated due to a locking mechanism with a stud screw and rotation. In addition, the adjustment is in the hygienic region, which requires cleaning after adjustment.

Other approaches to arranging and configuring a pre-tensioning device for specifying the head pressure are known in the prior art.

For example, CN 112850602 A discloses an apparatus in which a pre-tensioning device is arranged between a screw arm and an assembly with a roller for following a lifting cam. A cap gripper head is connected to the lower end of the screw arm.

DE 102021132348 A1, in turn, discloses an apparatus for closing containers, in which a pre-tensioning device has a compression spring element which is arranged within a lifting unit between an adjusting element and a closure receptacle.

The invention is based on the object of creating an improved apparatus for closing containers. Preferably, a particularly space-saving and easy-to-clean configuration is to be created for a pre-tensioning device of the apparatus.

### SUMMARY OF THE INVENTION

The object is achieved by the features of independent claim 1. Advantageous developments are specified in the dependent claims and the description.

One aspect of the present disclosure relates to an apparatus for closing a container. The apparatus has a closure element (e.g., closure cone) for applying a closure (e.g., roll-on closure, screw closure, push-on closure, crown cap and/or push-in closure) to the container. The apparatus further comprises a preferably manually adjustable (e.g., head pressure) pre-tensioning device with at least one elastic, pre-tensioned element (e.g., a helical spring, preferably a helical compression spring) for specifying a head pressure with which the closure element applies the closure to the container. The apparatus additionally has a lifting cam follower, preferably a roller, for following a lifting cam. The lifting cam follower is connected (among other things) via the pre-tensioning device to the closure element for vertical movement of the closure element when following the lifting cam. The at least one elastic, pre-tensioned element is arranged substantially at the same height as the lifting cam follower or above the lifting cam follower. Alternatively, a vertical extension of the at least one elastic, pre-tensioned element along a vertical axis (i.e., projected onto a vertical axis) and a vertical extension of the lifting cam follower along the vertical axis (i.e., projected onto the vertical axis) overlap or adjoin each other. In other words, the at least one elastic, pre-tensioned element and the lifting cam follower can overlap or adjoin each other, viewed in a horizontal direction (e.g., in an installation situation of the apparatus).

Advantageously, the pre-tensioning device can be arranged at the upper end of the apparatus in the region of the lifting cam. In contrast to the conventional apparatus, this arrangement allows the constructive length (constructive height) of the apparatus to be reduced substantially, preferably to the point at which the pre-tensioning device itself does not require any additional overall length. Advantageously, an existing installation space in the region of the lifting cam follower or above it can be used to completely accommodate the pre-tensioning device. In this way, the apparatus proposed here can save a constructive length of about 90 mm. This saved constructive length could be used for other elements, such as a seal, a wiper or a bellows, to further improve the apparatus. In addition, the conventional pre-tensioning device, which is made up of many individual parts and is difficult to clean, can be omitted directly above or in the closure head, which can significantly improve the cleanability of the apparatus. In this context, the arrangement of the pre-tensioning device proposed here may also allow the use of materials other than stainless steel material for the elements of the pre-tensioning device, since no cleaning with aggressive media takes place in this region. These and other advantages can be achieved in a particularly pronounced manner in the preferred embodiments described below.

In a further embodiment, the at least one elastic, pre-tensioned element is arranged on the outside of the apparatus and/or is arranged to be accessible from the outside.

In one embodiment, the apparatus further comprises a (e.g., substantially block-shaped) holder on which the lifting cam follower is held, preferably rotatably.

In a further embodiment, the at least one elastic, pre-tensioned element can be clamped between the holder and a bracket of the pre-tensioning device.

In a further embodiment, the at least one elastic, pre-tensioned element is arranged substantially at the same height as the holder.

In one embodiment variant, the at least one elastic, pre-tensioned element comprises two elastic, pre-tensioned elements arranged on opposite sides of the holder.

In a further embodiment variant, the apparatus further comprises a bearing component, preferably a bearing pin, wherein a lifting cylinder tube (e.g., lifting cylinder hollow shaft) of the apparatus is preferably mounted (e.g., rotatably) on the bearing component and/or a (e.g., externally toothed) toothed wheel (e.g., spur toothed wheel) of the apparatus is rotatably mounted for receiving a torque for screwing or rolling the closure onto the container. Optionally, the at least one elastic, pre-tensioned element can be arranged to act between the holder and the bearing component.

Preferably, the holder, the bearing component and/or the lifting cylinder tube can be arranged in a lifting connection between the lifting cam follower and the closure element.

In one embodiment, the bearing component is mounted in the holder so as to be vertically displaceable.

In a further embodiment, the apparatus further comprises a support plate which is fastened to the bearing component or is integrally connected to the bearing component. Preferably, the support plate can lift off the holder when the predetermined head pressure is exceeded when applying the closure to the container.

In one embodiment, the support plate and the at least one elastic, pre-tensioned element are arranged on opposite sides of at least one protruding support plate portion of the holder. Optionally, the at least one elastic, pre-tensioned element can be supported on the at least one protruding support plate portion, preferably via at least one bushing.

In a further embodiment, the pre-tensioning device has at least one adjusting element, preferably an adjusting screw, for adjusting a pre-tension of the at least one elastic, pre-tensioned element. Preferably, the at least one adjusting element can be arranged substantially at the same height as or above the lifting cam follower. Advantageously, in this way the head pressure can also be adjusted in the so-called gray area, which is far away from the cleaning zone or the hygienic region. In the case of a cleanroom partition or isolator, this is outside the cleanroom, which has the advantage that it is not necessary to intervene in the cleanroom to make adjustments. The very cumbersome adjustment using a threaded pin is made easier.

In one embodiment variant, a head of the at least one adjusting element (e.g., accessible from the outside) is arranged above the support plate, preferably lying against an upper side of the support plate.

In a further embodiment variant, the at least one adjusting element extends through the support plate, the at least one support plate portion and/or the at least one elastic, pre-tensioned element.

In a further embodiment variant, the at least one adjusting element is connected to the at least one support plate portion via at least one plain bearing.

In one embodiment, the pre-tensioning device further comprises a bracket into which the at least one adjusting element can be screwed for adjusting the pre-tension of the at least one elastic, pre-tensioned element. Preferably, the at least one elastic, pre-tensioned element can be supported on the bracket (e.g., via at least one bushing), and/or the bracket can have two, preferably L-shaped, arms and optionally a web that connects the two arms to one another.

In a further embodiment, the apparatus further comprises an ejector device which is configured to eject non-applied closures from the closure element, wherein a portion of the ejector device is arranged at the same height as the lifting cam follower and/or extends vertically upwards beyond the lifting cam follower. This advantageously means that the conventional ejector function with the slots in the lifting cylinder tube can be eliminated and the ejector function can be moved upwards. The resulting elimination of the slots in the lifting cylinder tube is advantageous in terms of hygiene.

In one embodiment, the ejector device comprises an ejector rod, preferably vertically movable or vertically fixed. Preferably, the ejector rod can extend through a bearing component of the apparatus. Alternatively or additionally, the ejector rod can be arranged, for example, at the same height as the pre-tensioning device, the at least one elastic, pre-tensioned element and/or the lifting cam follower. Alternatively or additionally, the ejector rod can extend vertically upwards, for example, beyond the pre-tensioning device, the at least one elastic, pre-tensioned element and/or the lifting cam follower.

Advantageously, since the overstroke during closing can now be compensated for at the top in the region of the lifting cam, the distance between the ejector rod and the closure can remain constant during the overstroke. Therefore, the ejector rod can be provided with less stroke and configured to the exact length. A further advantage is that the overstroke, as with the ejector rod, has no influence on the control rod of a gripper. This construction can therefore also be of great advantage for a gripping head.

Another aspect of the present disclosure relates to a capper, preferably a rotary capper, for closing containers. The capper comprises a (e.g., rotating and/or fixed) lifting cam and at least one apparatus as disclosed herein. The lifting cam follower of the at least one apparatus is guided on the lifting cam. Preferably, a plurality of the apparatuses are arranged distributed around a circumference of the capper.

A further aspect of the present disclosure relates to a container treatment plant (e.g., for controlling the temperature, producing, cleaning, coating, testing, filling, closing, pasteurizing, labeling, printing, marking, laser marking, and/or packaging containers for liquid or pasty media, preferably beverages, liquid foods or products from the pharmaceutical or healthcare industry). The container treatment plant can comprise the capper or the apparatus as disclosed herein.

For example, the containers can be realized as bottles, cans, canisters, cartons, vials, tubes, etc.

The preferred embodiments and features of the invention described above can be combined with one another as desired.

### BRIEF DESCRIPTION OF THE DRAWINGS

Further details and advantages of the invention are described below with reference to the accompanying drawings. in which:

FIG. 1 shows a side view of an apparatus according to an exemplary embodiment of the present disclosure;

FIG. 2 shows a further side view of the exemplary apparatus;

FIG. 3 shows a detail view of an upper portion of the further side view of FIG. 2;

FIG. 4 shows a sectional view of the exemplary apparatus; and

FIG. 5 shows a detail view of an upper portion of the sectional view of FIG. 4.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EXEMPLARY EMBODIMENTS

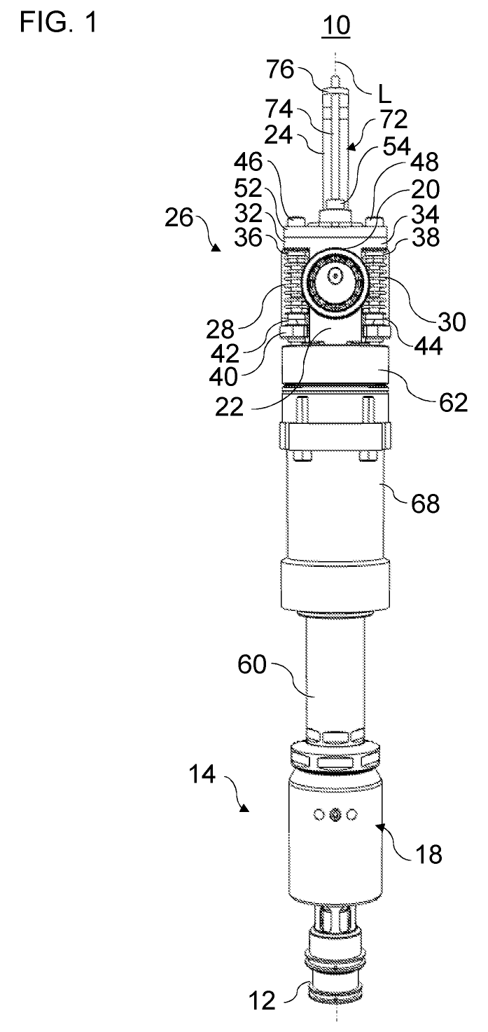

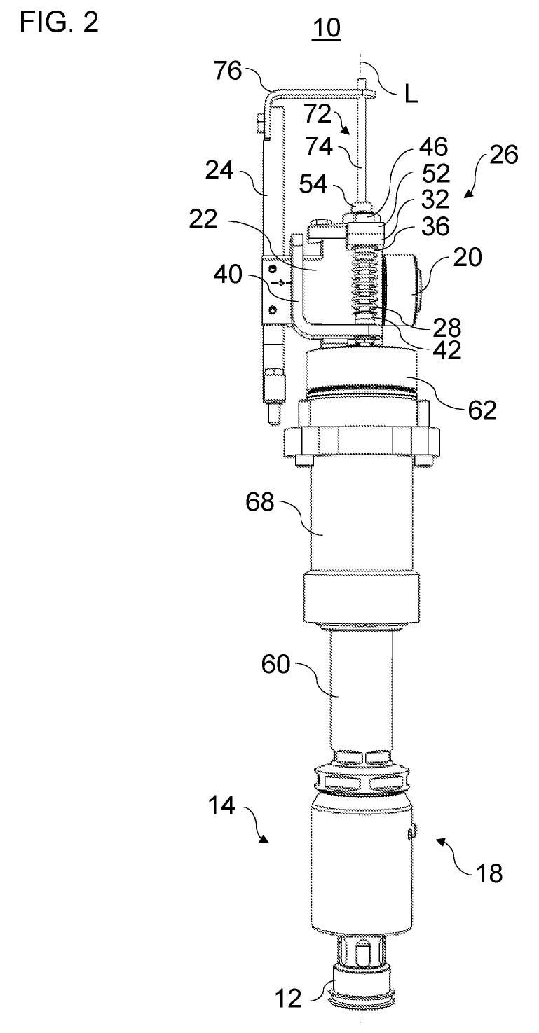

FIGS. 1 to 5 show an apparatus 10 for closing a container.

Depending on the design, the apparatus 10 can close a container, for example, with a roll-on closure, a screw closure, a push-on closure, a crown cap and/or a push-in closure. In the embodiment shown in FIGS. 1 to 5, the apparatus 10 can screw a screw closure onto a container.

For example, a capper can have one, or preferably a plurality, of the apparatuses 10 for the simultaneous or temporally overlapping closing of a plurality of containers. The capper can be, for example, a rotary capper. The apparatuses 10 can be arranged distributed around a circumference of a capper carousel of the capper. Alternatively, the capper can, for example, be a linear capper, e.g., with a plurality of apparatuses 10 arranged in series next to one another or one after the other.

For example, the capper can be comprised in a container treatment plant. The capper can be arranged downstream of or integrated with a filler for filling the containers with a liquid or pasty filling material.

The apparatus 10 has a closure element 12, a lifting cam follower 20, and a pre-tensioning device 26.

The closure element 12 is configured to apply a closure to a container.

Preferably, the closure element 12 can have a closure receptacle for a closure. A screw cap held in the closure receptacle can be screwed onto a container when the closure element 12 is rotated.

The closure element 12 is preferably realized as a, preferably toothed, closure cone. For example, an elastic holding ring for holding a screw cap can be arranged at the lower end of the closure element 12.

For example, the closure element 12 can be part of a closure head 14.

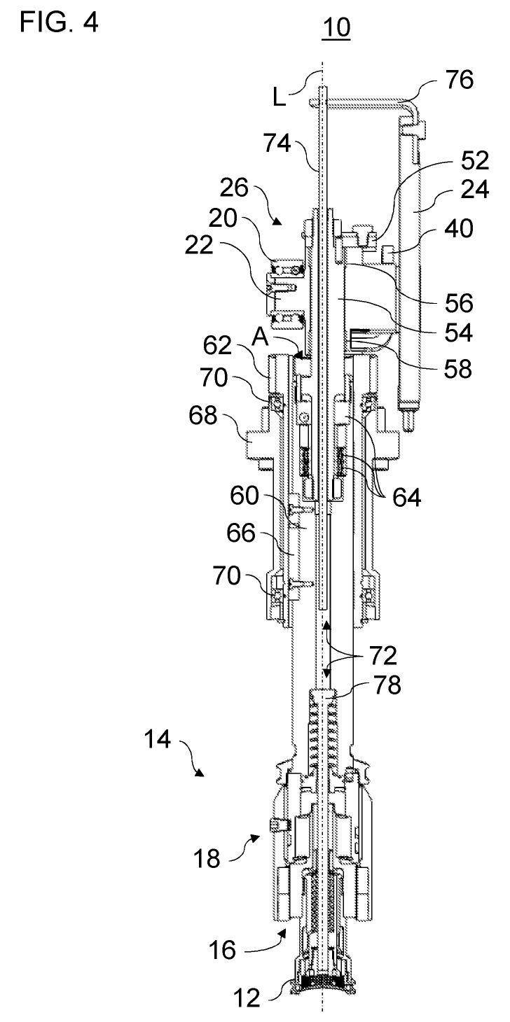

The closure head 14 can be rotatable, for example. The closure head 14 can, for example, have a magnetic coupling 16 (visible only in FIG. 4). Preferably, an output side of the magnetic coupling 16 can be connected to the closure element 12. Alternatively or additionally, a drive side of the magnetic coupling 16 can be connected to an adjusting mechanism 18 for adjusting an overlap of the magnetic rings of the magnetic coupling 16 to adjust a maximum closing torque.

The lifting cam follower 20 is configured to follow a lifting cam. The lifting cam can be a fixed part of the capper. The lifting cam can preferably be a circumferential (closed) lifting cam. With the lifting cam, a lifting of the apparatus 10 can be controlled via the lifting cam follower 20. The lifting cam can also be referred to as a control cam for controlling a lifting of the apparatus 10.

The lifting cam can preferably have two opposite running surfaces. The two opposite running surfaces can preferably be vertically spaced from each other. The lifting cam follower 20 can be arranged between the two running surfaces. The lifting cam follower 20 can be guided by the lifting cam, preferably its two opposite running surfaces.

The lifting cam follower 20 is preferably configured as a roller (track roller), as shown in FIGS. 1 to 5. Alternatively, the lifting cam follower 20 can be configured, for example, as a sliding piece (sliding shoe).

The lifting cam follower 20 is connected to the closure element 12 via the pre-tensioning device 26 for vertically moving the closure element 12 when following the lifting cam. The vertical movement can take place along a longitudinal central axis L of the apparatus 10.

In detail, the lifting cam follower 20 can be connected to the closure element 12, for example, via a holder 22, the pre-tensioning device 26, a bearing component 54, a lifting cylinder tube 60, the adjustment mechanism 18 and/or the magnetic coupling 16.

Preferably, the lifting cam follower 20 can be held on the holder 22, which is preferably substantially block-shaped. The holder 22 can preferably hold the lifting cam follower 20 rotatably. The holder 22 can be a roller holder for the lifting cam follower 20 configured as a roller.

The holder 22 can for example have a shoulder on which the lifting cam follower 20 is arranged. The shoulder can for example be cylindrical. The lifting cam follower 20 can be secured axially on the shoulder. For example, the lifting cam follower 20 can be secured axially on the shoulder by a retaining ring or a retaining washer which is for example fastened to the shoulder on the front side.

Preferably, the holder 22 can be secured against rotation by an anti-rotation lock 24. The anti-rotation lock 24 can preferably secure the holder 22 in such a way that it cannot be rotated about a longitudinal axis of the anti-rotation lock 24, which can be parallel to the longitudinal central axis L.

The anti-rotation lock 24 can, for example, substantially have a bar or strip shape. The anti-rotation lock 24 can be oriented upright. The holder 22 can be guided vertically (longitudinally) on the anti-rotation lock 24. The holder 22 can thus move along the anti-rotation lock 24.

Preferably, the holder 22 can be guided in sliding fashion on opposite longitudinal sides of the anti-rotation lock 24. The holder 22 can, for example, be connected to the anti-rotation lock 24 via two opposite sliding plates. The anti-rotation lock 24 can be arranged between the two sliding plates.

The anti-rotation lock 24 can for example be fastened to the capper, e.g., to a capper carousel of the capper and/or by a screw connection.

The pre-tensioning device 26 has at least one elastic and (elastically) pre-tensioned element 28, 30. Preferably, two elastic and pre-tensioned elements 28 and 30 are included. Optionally, the pre-tensioning device 26 can for example comprise another bracket 40 and/or at least one adjusting element 46, 48.

The at least one element 28, 30 can specify a so-called head pressure with which the closure element 12 applies the closure to the container. Preferably, the at least one element 28, 30 can be a helical spring, particularly preferably a helical compression spring.

The at least one element 28, 30 is arranged (with respect to the longitudinal central axis L) substantially at the same height as the lifting cam follower 20, as shown by way of example in FIGS. 1 to 3. In detail, a vertical extension of the at least one element 28, 30 along a vertical axis (e.g., longitudinal central axis L) and a vertical extension of the lifting cam follower 20 along the vertical axis can preferably overlap or adjoin one another.

For example, the at least one element 28, 30 can be arranged slightly lower or higher than the lifting cam follower 20. For example, the at least one element 28, 30 can be offset obliquely downwards or obliquely upwards with respect to the lifting cam follower 20.

For example, an uppermost point of the at least one element 28, 30 can be arranged higher with respect to the vertical axis than a lowest point of the lifting cam follower 20, so that the said overlap results, or can be adjacent to it with respect to the vertical axis. Alternatively, for example, a lowest point of the at least one element 28, 30 can be arranged lower with respect to the vertical axis than an uppermost point of the lifting cam follower 20, so that the said overlap results, or can be adjacent to it with respect to the vertical axis.

Alternatively, the at least one element 28, 30 can be arranged above the lifting cam follower 20 with respect to a vertical axis (= longitudinal central axis L). For example, a lowest point of the at least one element 28, 30 can be arranged higher with respect to the vertical axis than an uppermost point of the lifting cam follower 20.

For example, the at least one element 28, 30 can be arranged substantially at the same height as the holder 22. Preferably, the element 28 and the additional element 30 can be arranged at opposite outer sides of the holder 22. The holder 22 can be arranged between the element 28 and the additional element 30.

For example, one of the elements 28 and 30 can be arranged on a side of the holder 22 facing in a forward direction of travel of the apparatus 10. The other of the elements 28 and 30 can be arranged on a side of the holder 22 facing in a reverse direction of travel of the apparatus 10.

Preferably, the at least one element 28, 30 is arranged on the outside of the apparatus 10 and is accessible from the outside. As already mentioned, the at least one element 28, 30 can be arranged, for example, on an outer side of the holder 22.

The at least one element 28, 30 can be supported on the holder 22. Preferably, an upper end of the at least one element 28, 30 can be supported on the holder 22. The holder 22 can in turn be supported on the bearing component 54, e.g., via a support plate 52.

Preferably, the at least one element 28, 30 can be supported on at least one laterally protruding support plate portion 32, 34 of the holder 22. The at least one support plate portion 32, 34 is arranged for example in an upper region of the holder 22.

For example, the element 28 can be supported on the support plate portion 32. The further element 30 can, for example, be supported on the further support plate portion 34. The support plate portions 32 and 34 can protrude on opposite sides of the holder 22.

Preferably, the at least one element 28 is supported on the at least one support plate portion 32 via at least one bushing 36, 38. Preferably, the at least one bushing 36, 38 can engage in the at least one element 28, 30. Preferably, a longitudinal axis of the at least one bushing 36, 38 can be parallel to the longitudinal central axis L. For example, the element 28 can be supported on the support plate portion 32 via the bushing 36. The further element 30 can be supported on the further support plate portion 34 via the bushing 38.

The at least one element 28, 30 can be supported on the bracket 40. Preferably, a lower end of the at least one element 28, 30 can be supported on the bracket 40.

The bracket 40 can for example have two arms and a web connecting the two arms to one another. The arms can preferably each be L-shaped. The holder 22 can preferably be arranged between the two arms. The web can preferably be arranged above the holder 22. Alternatively, the web can be arranged for example under the holder 22.

For example, the element 28 can be supported on one of the two arms of the bracket 40. The further element 30 can be supported on the other of the two arms of the bracket 40.

Preferably, the at least one element 28 is supported on the bracket 44 via at least one bushing 42, 44. Preferably, the at least one bushing 42, 44 can engage in the at least one element 28, 30. For example, the element 28 can be supported on one of the two arms of the bracket 40 via the bushing 42. The further element 30 can be supported via the bushing 44 on the other of the two arms of the bracket 40.

Particularly preferably, the at least one element 28, 30 can be clamped between the bracket 40 and the holder 22, preferably the at least one support plate portion 32, 34 of the holder 22.

It is possible that the pre-tensioning device 26 is manually adjustable to adjust the head pressure. For example, the pre-tensioning device 26 can have at least one adjusting element 46, 48 for adjusting a pre-tension of the at least one element 28, 30. Preferably, the at least one adjusting element 46, 48 can be an adjusting screw.

Preferably, two adjusting elements 46, 48 are included. The adjusting element 46 can be arranged to adjust an elastic pre-tension of the element 28. The (further) adjusting element 48 can be arranged to adjust a pre-tension of the element 28. The adjusting elements 46 and 48 can preferably be arranged on opposite sides of the holder 22.

For example, a head of the at least one adjusting element 46, 48 can be arranged above the support plate 52. The head can for example lie on the support plate 52. Preferably, a tool for screwing the adjusting element can be attached to the head of the at least one adjusting element 46, 48.

Preferably, the at least one adjusting element 46, 48 can extend through the support plate 52, the at least one support plate portion 32, 34 and the at least one element 28, 30. For example, the adjusting element 46 can extend through the support plate 52, the support plate portion 32 and the element 28. The further adjusting element 48 can for example extend through the support plate 52, the further support plate portion 34 and the further element 30.

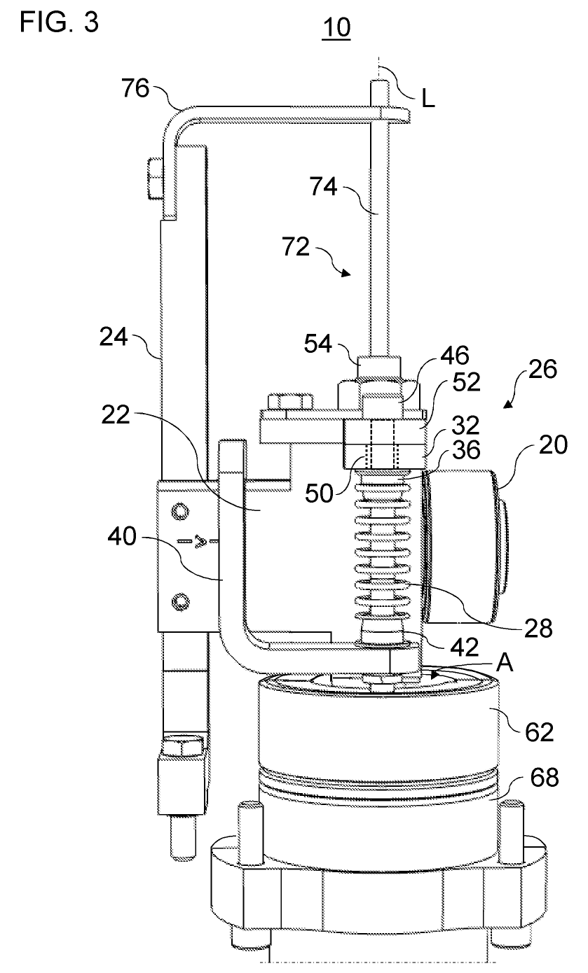

Preferably, the at least one adjusting element 46, 48 can be connected to the at least one support plate portion 32, 34 via at least one plain bearing 50, as shown schematically in FIG. 3. Preferably, the plain bearing 50 can be a plain bearing bushing. A longitudinal axis of the at least one plain bearing 50 is preferably aligned parallel to the longitudinal central axis L. For example, the adjusting element 46 can be connected to the support plate portion 32 via the plain bearing 50. The further adjusting element 48 can be connected to the further support plate portion 34 via a further plain bearing.

Preferably, the at least one adjusting element 46, 48 can be screwed into the bracket 40 to adjust the pre-tension of the at least one element 28, 30. The desired pre-tension can be specified depending on the screw-in depth.

For example, the at least one adjusting element 46, 48 can be screwed directly into the bracket 40 or (indirectly) into at least one nut received in or on the bracket 40. For example, the adjusting element 46 can be screwed into a free end region of one of the two arms of the bracket 40 (directly or indirectly). The adjusting element 48 can for example be screwed (directly or indirectly) into a free end region of the other of the two arms of the bracket 40.

The support plate 52 can be arranged above the holder 22. Preferably, the support plate 52 and the at least one element 28, 30 can be arranged on opposite sides of the at least one protruding support plate portion 32, 34 of the holder 22.

The support plate 52 can be fastened to the bearing component 54 for example with a non-positive fit, a positive fit, and/or by material bonding. Alternatively, the support plate 52 can for example be integrally connected to the support plate 52.

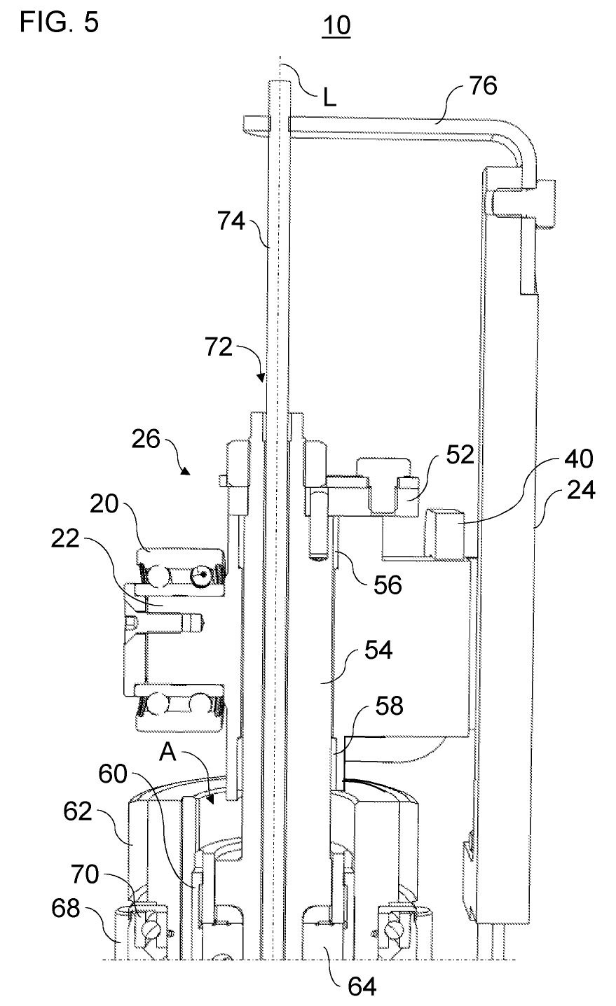

The bearing component 54 and the holder 22 can be movable relative to each other with respect to the longitudinal central axis L. Most preferably, the bearing component 54 can be mounted in the holder 22 so as to be vertically displaceable. For example, the bearing component 54 can be displaceably mounted in the holder 22 via at least one plain bearing 56, 58 (see FIGS. 4 and 5). Preferably, a longitudinal axis of the at least one plain bearing 56, 58 can be identical to the longitudinal central axis L. The at least one plain bearing 56, 58 is preferably configured as a plain bearing bushing.

For example, a plain bearing 56 can be arranged at an upper end of a through-hole through the holder 22. Another plain bearing 58 can be arranged at a lower end of the through-hole. The bearing component 54 can extend through the through-hole and be connected to the holder 22 via the plain bearings 56, 58.

The at least one element 28, 30 can be arranged operatively between the holder 22 and the bearing component 54. In detail, the holder 22 can be supported on the bracket 40 via the at least one element 28, 30. The bracket 40 can in turn be supported via the at least one adjusting element 46, 48 on the support plate 52, which in turn is supported on the bearing component 55.

Preferably, the bearing component 54 can be substantially pin-shaped or configured as a bearing pin.

Preferably, the bearing component 54 can support a lifting cylinder tube 60 and a toothed wheel 62 (shown only schematically in the figures without teeth) rotatably about the longitudinal central axis L. For example, the bearing component 54 can be arranged inside the lifting cylinder tube 60.

The lifting cylinder tube 60 can connect the bearing component 54 and the closure head 14 and thus the closure element 12 to one another. For example, the lifting cylinder tube 60 can be connected to the adjustment mechanism 18 of the closure head 14. A lifting movement of the bearing component 54 can be transmitted via the lifting cylinder tube 60 to the closure head 14 and thus to the closure element 12.

The lifting cylinder tube 60 can be arranged internally to the toothed wheel 62. The at least one pivot bearing 64 can rotatably connect the bearing component 54 on the one hand and the lifting cylinder tube 60 and the toothed wheel 62 on the other hand (see FIGS. 4 and 5). The at least one pivot bearing 64 can for example comprise at least one angular contact ball bearing and/or at least one deep groove ball bearing.

Preferably, the toothed wheel 62 can be connected to the lifting cylinder tube 60 in a rotationally fixed manner. For example, the toothed wheel 62 can be connected to the lifting cylinder tube 60 in a rotationally fixed manner via a key 66 (see FIG. 4).

Preferably, the bearing component 54 and the lifting cylinder tube 60 can be displaceable relative to the toothed wheel 62 with respect to the longitudinal central axis L.

The toothed wheel 62 can also be rotatably supported by a bearing cup 68. The bearing cup 68 can surround a portion of the toothed wheel 62. Preferably, a longitudinal axis of the bearing cup 68 can be identical to the longitudinal central axis L. At least one pivot bearing 70 can connect the bearing cup 68 and the toothed wheel 62 to one another in rotatable fashion. The bearing cup 68 can for example be fastened to the capper, e.g., to a capper carousel of the capper and/or by a screw connection.

The toothed wheel 62 can be connected to a drive device, e.g., an electric motor (not shown in the figures). The drive device can drive the toothed wheel 62 and thus the lifting cylinder tube 60 to rotate. The toothed wheel 62 can receive a torque from the drive device. The lifting cylinder tube 60 can accordingly act as a lifting cylinder hollow shaft which is both rotatable (by the toothed wheel 62) and vertically displaceable (via the lifting cam follower 20). The lifting cylinder tube 60 can drive the closure head 14 and thus the closure element 12 to rotate in order to apply a screw closure or a roll-on closure to a container.

However, as already mentioned, it is also possible for the apparatus 10 not to be configured to apply a screw cap to a container. Instead, the apparatus 10 can be configured, for example, to apply a push-on closure, a crown cap and/or a push-in closure. In such an embodiment, for example, the toothed wheel 62 and the bearing cup 68, as well as a rotatable bearing of the lifting cylinder tube 60, can be omitted.

If, during operation, the head pressure predetermined by the at least one element 28, 30 is exceeded when the closure element 12 is lowered onto the container by the lifting cam follower 20, the support plate 52 can lift off from the holder 22, e.g., to compensate for the overstroke. Preferably, the holder 22 can then move vertically relative to the support plate 52 and the bearing component 54 and, for example, penetrate into a receiving space A (see Figures3 to 5).

Preferably, the receiving space A can for example be dimensioned such that a vertical relative movement between the support plate 52/the bearing component 54 and the holder 22 of approx. ≤ 20 mm is possible. Preferably, the receiving space A can be arranged between the toothed wheel 62 and the bearing component 54. Particularly preferably, the receiving space A is substantially annular. For example, the receiving space A can be arranged inside the toothed wheel 62 and/or outside the bearing component 54. For example, a longitudinal axis of the receiving space A can be identical to the longitudinal central axis L.

Optionally, the apparatus can, for example also comprise an ejector device 72. The ejector device 72 can be configured to eject a closure not applied to a container from the closure element 12.

Preferably, the ejector device 72 can have an ejector rod 74. A longitudinal axis of the ejector rod 74 can be identical to the longitudinal central axis L.

Preferably, the ejector rod 74 can be at the same height as the pre-tensioning device 26, the at least one element 28, 30 and/or the lifting cam follower 20 and can optionally extend vertically upwards beyond these.

In the illustrated embodiment, the ejector rod 74 is fixed vertically. For example, the ejector rod 74 can be fixed to the capper carousel of the capper, e.g., via a bracket 76 and/or the anti-rotation lock 24. Preferably, an upper end of the ejector rod 74 can be fastened to the bracket 76 with a non-positive fit, a positive fit, and/or a material bond. The preferably L-shaped bracket 76 can in turn be fastened to the anti-rotation lock 24.

The ejector rod 74 can extend through the bearing component 54. During a vertical movement of the bearing component 54, the lifting cylinder tube 60 and the closure head 14 upwards, an upper end of a further ejector rod 78, which is connected via an elastic and pre-tensioned element for example to the lifting cylinder tube 60 and/or the closure head 14, can meet a lower end of the ejector rod 74 at a certain point and strike against it. A relative vertical movement, made possible by the aforementioned elastic and pre-tensioned element, between the further ejector rod 78 on the one hand and the closure head 14 on the other hand then leads to a penetration of the further ejector rod 78 into a closure receptacle of the closure element 12 in order to eject any closure which may still be located therein.

Alternatively, the ejector rod 74 can be moved vertically with the bearing component 54, the lifting cylinder tube 60 and/or the closure head 14, for example via an elastic and pre-tensioned element. The ejector rod 74 can then move upwards along with a vertical movement of the bearing component 54, the lifting cylinder tube 60 and the closure head 14 until it strikes a stop (such as the bracket 76) and is stopped. A relative vertical movement, made possible by the aforementioned elastic and pre-tensioned element, between the ejector rod 74 on the one hand and the bearing component 54, the lifting cylinder tube 60, and the closure head 14 on the other hand then leads to a penetration of the ejector rod 74 into a closure receptacle of the closure element 12 in order to eject any closure which may still be located therein.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or configuration of the closure element, the pre-tensioning device, the at least one elastic, pre-tensioned element and/or the lifting cam follower of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 apparatus for closing a container

12 closure element

14 closure head

16 magnetic coupling

18 adjustment mechanism

20 lifting cam follower

22 holder

24 anti-rotation lock

26 pre-tensioning device

28 elastic, pre-tensioned element

30 (further) elastic, pre-tensioned element

32 support plate portion

34 (further) support plate portion

36 bushing

38 (additional) bushing

40 bracket

42 (additional) bushing

44 (further additional) bushing

46 adjusting element

48 (additional) adjusting element

50 plain bearing

52 support plate

54 bearing component

56 plain bearing

58 (additional) plain bearing

60 lifting cylinder tube

62 toothed wheel

64 pivot bearing

66 key

68 bearing cup

70 pivot bearing

72 ejector device

74 ejector rod

76 bracket

78 additional ejector rod

A receiving space

L longitudinal central axis

What is claimed is:

1. An apparatus for closing a container, comprising:
a closure element for applying a closure to the container;
a pre-tensioning device with at least one elastic pre-tensioned element for specifying a head pressure with which the closure element applies the closure to the container; and
a lifting cam follower for following a lifting cam,
wherein:
the lifting cam follower is connected to the closure element via the pre-tensioning device for vertically moving the closure element when following the lifting cam, and
one of:
the at least one elastic pre-tensioned element is arranged at substantially the same height as the lifting cam follower;
the at least one elastic pre-tensioned element is arranged above the lifting cam follower; and
a vertical extension of the at least one elastic pre-tensioned element along a vertical axis and a vertical extension of the lifting cam follower along the vertical axis overlap or adjoin one another.

2. The apparatus according to claim 1, wherein:the at least one elastic pre-tensioned element is at least one of arranged on the outside of the apparatus and arranged to be accessible from the outside.

3. The apparatus according to claim 1, wherein at least one of:the pre-tensioning device is manually adjustable;the lifting cam follower includes a roller;the apparatus includes a holder on which the lift cam follower is rotatably held; andthe apparatus includes a bearing pin, wherein, on the bearing pin at least one of a lifting cylinder tube of the apparatus is mounted, and a toothed wheel of the apparatus is
rotatably mounted, for receiving a torque for screwing or rolling the closure onto the container.

4. The apparatus according to claim 1, further comprising:a holder on which the lifting cam follower is held.

5. The apparatus according to claim 4, wherein:the at least one elastic pre-tensioned element is clamped between the holder and a bracket of the pre-tensioning device.

6. The apparatus according to claim 5, wherein at least one of:the at least one elastic pre-tensioned element is arranged at substantially the same height as the holder; andthe at least one elastic pre-tensioned element comprises two elastic pre-tensioned elements arranged on opposite sides of the holder.

7. The apparatus according to claim 5, further comprising:a bearing component, wherein, on the bearing component, at least one of a lifting cylinder tube of the apparatus is mounted, and a toothed wheel of the apparatus is rotatably mounted, for receiving a torque for screwing or rolling the closure onto the container,wherein the at least one elastic pre-tensioned element is arranged operatively between the holder and the bearing component.

8. The apparatus according to claim 7, wherein:the bearing component is mounted vertically displaceably in the holder.

9. The apparatus according to claim 7, further comprising:a support plate which is fastened to the bearing component or is integrally connected to the bearing component in one piece,
wherein the support plate lifts off the holder when the predetermined head pressure is exceeded when applying the closure to the container.

10. The apparatus according to claim 9, wherein:the support plate and the at least one elastic pre-tensioned element are arranged on opposite sides of at least one protruding support plate portion of the holder.

11. The apparatus according to claim 10, wherein the at least one elastic pre- tensioned element is supported, via at least one bushing, on the at least one protruding support plate portion.

12. The apparatus according to claim 1, wherein the pre-tensioning device further comprises:at least one adjusting element for adjusting a pre-tension of the at least one elastic pre-tensioned element.

13. The apparatus according to claim 12, wherein at least one of the following is met:a head of the at least one adjusting element is arranged above the support plate;the at least one adjusting element extends through at least one of the support plate, the at least one support plate portion and the at least one elastic pre-tensioned element; andthe at least one adjusting element is connected to the at least one support plate portion via at least one plain bearing.

14. The apparatus according to claim 12, wherein the pre-tensioning device further comprises:a bracket into which the at least one adjusting element can be screwed to adjust the pre-tension of the at least one elastic pre-tensioned element.

15. The apparatus according to claim 12, wherein at least one of:the at least one adjusting element includes an adjusting screw;
the at least one adjusting element is arranged at least at the same height as the lifting cam follower;a head of the at least one adjusting element is arranged above the support plate and lying against an upper side of the support plate;the apparatus includes a bracket into which the at least one adjusting element can be screwed, and the at least one elastic pre-tensioned element is supported on the bracket; andthe apparatus includes a bracket into which the at least one adjusting element can be screwed, and the bracket has two L-shaped arms and a web that connects the two arms to one another.

16. The apparatus according to claim 1, further comprising:an ejector device which is configured to eject non-applied closures from the closure element, wherein a portion of the ejector device is at least one of arranged at the same height as the lifting cam follower and extends vertically upwards beyond the lifting cam follower.

17. The apparatus according to claim 16, wherein:the ejector device has an ejector rod, which at least one of:- extends through a bearing component of the apparatus;- is arranged at the same height as at least one of the pre-tensioning device, the at least one elastic pre-tensioned element and the lifting cam follower; and- extends vertically upwards beyond at least one of the pre-tensioning device, the at least one elastic pre-tensioned element and the lifting cam follower.

18. The apparatus according to claim 17, wherein the ejector rod is one of vertically movable and vertically fixed.

19. A capper for closing containers, the capper comprising: a lifting cam; and at least one apparatus according to claim 1, wherein the lifting cam follower of the at least one apparatus is guided on the lifting cam.

20. The capper according to claim 19, wherein at least one of:the capper is a rotary capper; andthe at least one apparatus is a plurality of the apparatuses that are arranged distributed around a circumference of the capper.
